(19) United States
(12) Patent Application Publication
(10) Pub. No.: US 2025/0150152 A1
(43) Pub. Date: May 8, 2025

(54) PERIODIC BEAM SWITCHING REPORT FOR HIGH ALTITUDE PLATFORM STATIONS

(71) Applicant: QUALCOMM Incorporated, San Diego, CA (US)

(72) Inventors: Kangqi LIU, San Diego, CA (US); Ruiming ZHENG, Beijing (CN); Chao WEI, Beijing (CN); Hao XU, Beijing (CN)

(21) Appl. No.: 18/835,623

(22) PCT Filed: Apr. 20, 2022
(86) PCT No.: PCT/CN2022/087793

§ 371 Date: Aug. 2, 2024

(51) Int. Cl. H04B 7/08; H04W 24/10

(52) U.S. Cl. CPC H04B 7/088; H04W 24/10

(57) ABSTRACT

Certain aspects of the present disclosure provide techniques for method for wireless communications by a network entity, generally including transmitting, to a user equipment (UE) while the network entity is deployed on an aerial platform, a periodic beam switching configuration and receiving, from the UE, a report with beam measurement results in accordance with the periodic beam switching configuration.

### BACKGROUND

### Field of the Disclosure

Aspects of the present disclosure relate to wireless communications, and more particularly, to techniques for enhancing beam measurement reporting for high altitude platform stations (HAPS).

### Description of Related Art

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available wireless communication system resources with those users

Although wireless communication systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communication systems, increasing the ability for different types of devices to intercommunicate, increasing the number and type of wireless communication mediums available for use, and the like. Consequently, there exists a need for further improvements in wireless communications systems to overcome the aforementioned technical challenges and others.

### SUMMARY

One aspect provides a method for wireless communication by a network entity, including transmitting, to a user equipment (UE) while the network entity is deployed on an aerial platform, a periodic beam switching configuration; and receiving, from the UE, a report with beam measurement results in accordance with the periodic beam switching configuration.

One aspect provides a method for wireless communication by a UE, including receiving, from a network entity deployed on an aerial platform, a periodic beam switching configuration; and transmitting, to the network entity, a report with beam measurement results in accordance with the periodic beam switching configuration.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communication network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communication network.

FIG. 5 depicts example network elements at different altitudes.

FIGS. 6A and 6B depict example instability of HAPS platforms that aspects of the present disclosure may help mitigate.

FIG. 7 is a call flow diagram for HAPS initiated beam measurement reporting, in accordance with aspects of the present disclosure.

FIG. 8 is a call flow diagram for beam measurement reporting for UE initiated beam measurement reporting, in accordance with aspects of the present disclosure.

FIG. 9 depicts a method for wireless communication.

FIG. 10 depicts a method for wireless communication.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for enhancing beam measurement reporting in high altitude platform stations (HAPS).

Non-terrestrial networks (NTNs) are one option being explored to expand coverage of wireless networks. For example, NTNs may help provide coverage to rural areas where conventional network infrastructure does not currently exist and where there may be impediments to deploying such. NTN generally refers to a network that involves non-terrestrial (aerial) object.

NTNs include satellite communication networks that utilize platforms such as geosynchronous Earth orbiting (GEO), medium Earth orbiting (MEO), and low Earth orbiting (LEO) satellites. NTNs also include HAPS that utilize airborne platforms, such as airplanes, balloons, and airships. Air-to-ground networks typically provide connectivity between the aerial platform-deployed systems and a network of ground stations, which may ultimately connect to conventional network infrastructure. Stations in the ground network may be similar to base stations of conventional terrestrial networks (TNs), but have antennas optimized to accommodate the larger distances between the ground stations and platforms.

For example, HAPS platforms are typically deployed at altitudes between 20-50 km. While HAPS scenarios may be able to provide wireless service in certain areas, there are challenges that impact stability of the performance. For example, one challenge is that interference from TN base stations may impact the performance for UEs accessed in HAPS.

Another challenge is that the HAPS platform deployed base station antenna surface is not stable. In contrast to satellites that transmit information about their current and predicted location (referred to as ephemeris data), HAPS platforms are assumed to be static. In practice, however, a HAPS platform deployed in the stratosphere (such as a blimp), may rapidly move (jerk up-and-down/side-to-side), even when using a stabilizing device. Due to the larger distance, a relatively small angular movement (e.g., of just one degree) may lead to a significant coverage bias (e.g., of several kilometers) on the ground, given typical beam widths and coverage diameters.

Aspects of the present disclosure, however, may help mitigate the impact of such rapid movement by providing enhancements to beam measurement and beam management procedures. For example, as will be described in greater detail below, a UE may be configured to perform beam measurement according to a periodic beam switching pattern that may be designed to take into account the rapid movement of HAPS platform.

Thus, beam measurements reported in accordance with such a configured pattern may result in quicker adaptation in response to rapid HAPS platform movements, which may help mitigate coverage bias and lead to more stable performance. As a result, aspects of the present disclosure may help achieve the greater goal of HAPS deployments to provide vital coverage to underserved areas.

### Introduction to Wireless Communication Networks

The techniques and methods described herein may be used for various wireless communications networks. While aspects may be described herein using terminology commonly associated with 3G, 4G, and/or 5G wireless technologies, aspects of the present disclosure may likewise be applicable to other communication systems and standards not explicitly mentioned herein.

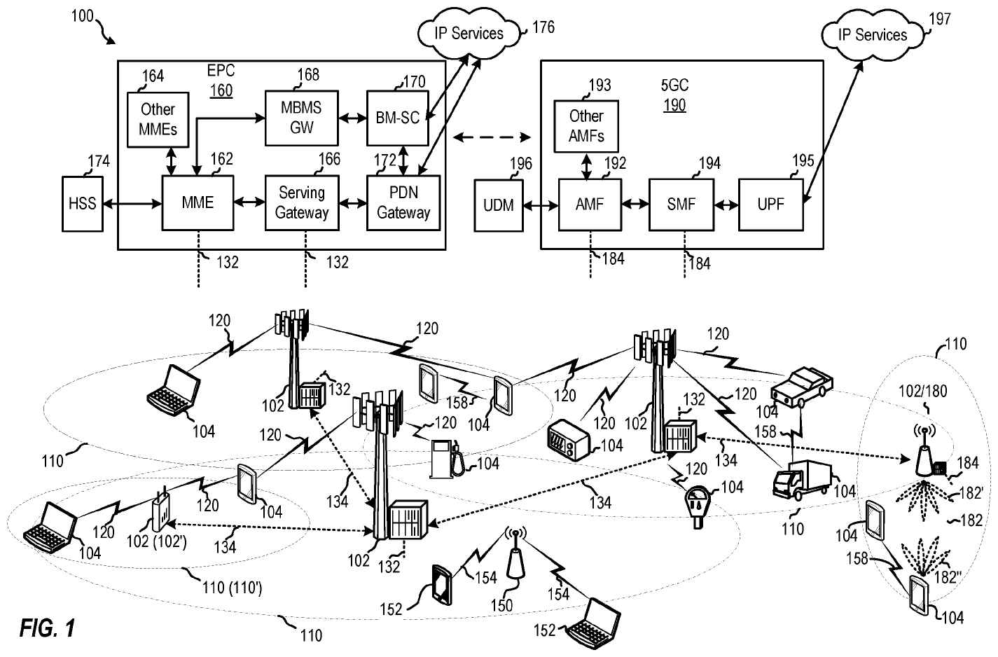

FIG. 1 depicts an example of a wireless communication network 100, in which aspects described herein may be implemented.

Generally, wireless communication network 100 includes various network entities (alternatively, network elements or network nodes). A network entity is generally a communications device and/or a communication function performed by a communications device. For example, various functions of a network as well as various devices associated with and interacting with a network may be considered network entities.

In the depicted example, wireless communication network 100 includes base stations (BSs) 102, user equipments (UEs) 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with UEs 104 via communications links 120. The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and others. Each of BSs 102 may provide communication coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communication coverage for a macro cell (covering relatively large geographic area), a pico cell (covering relatively smaller geographic area, such as a sports stadium), a femto cell (relatively smaller geographic area (e.g., a home)), and/or other types of cells.

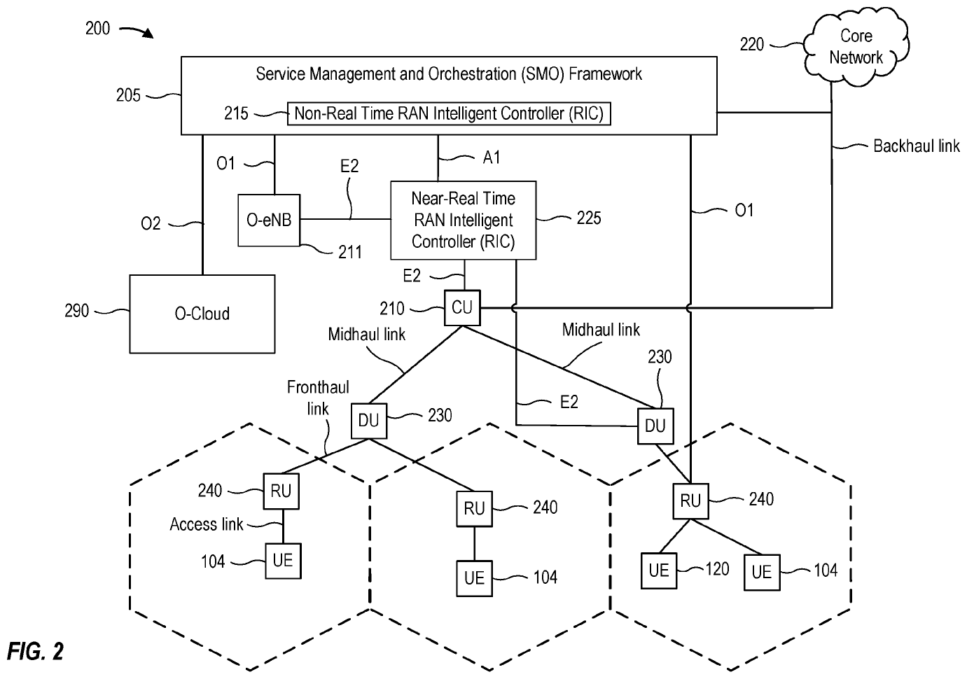

While BSs 102 are depicted in various aspects as unitary communications devices, BSs 102 may be implemented in various configurations. For example, one or more components of base station may be disaggregated, including a central unit (CU), one or more distributed units (DUs), one or more radio units (RUS), a radio unit (RU), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communication network 100 may also be configured to support different radio access technologies, such as 3G, 4G, and 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communication network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A base station configured to communicate using mm Wave/near mm Wave radio frequency bands (e.g., a mmWave base station such as BS 180) may utilize beamforming (e.g., 182) with a UE (e.g., 104) to improve path loss and range.

The communication links 120 between BSs 102 and, for example, UEs 104, may be through one or more carriers, which may have different bandwidths (e.g., 5, 10, 15, 20, 100, 400, and other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. BS 180 may also receive the beamformed signal from UE 104 in one or more receive directions 182′. Base station 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communication network 100 further includes a Wi-Fi AP 150 in communication with Wi-Fi stations (STAs) 152 via communication links 154 in, for example, a 2.4 GHz and/or 5 GHz unlicensed frequency spectrum.

Certain UEs 104 may communicate with each other using device-to-device (D2D) communication link 158. D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172 in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as Al policies).

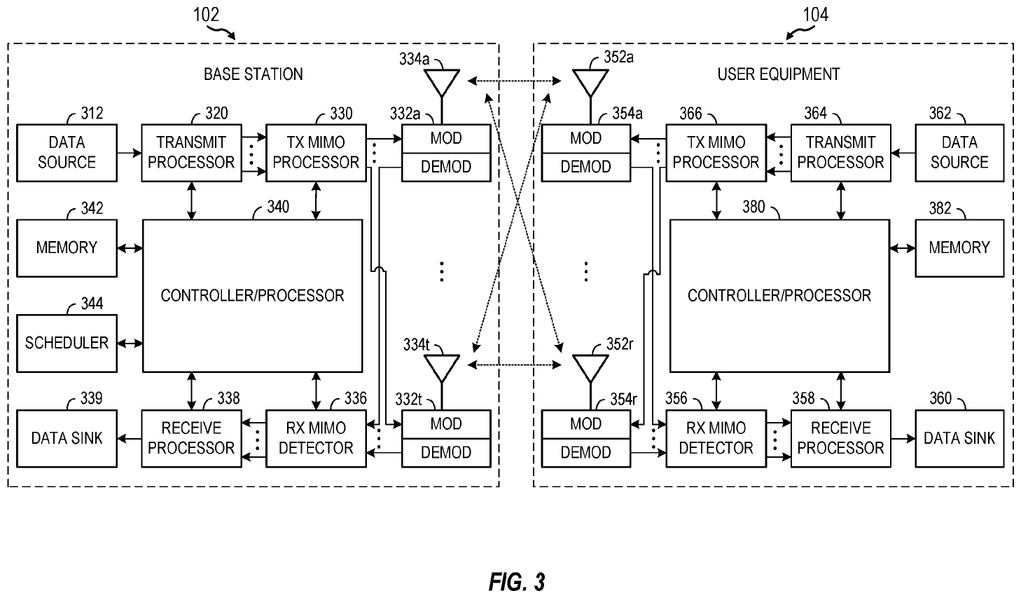

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., data source 362) and wireless reception of data (e.g., data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and other aspects described herein.

In some aspects, a processor may be configured to perform various operations, such as those associated with the methods described herein, and transmit (output) to or receive (obtain) data from another interface that is configured to transmit or receive, respectively, the data.

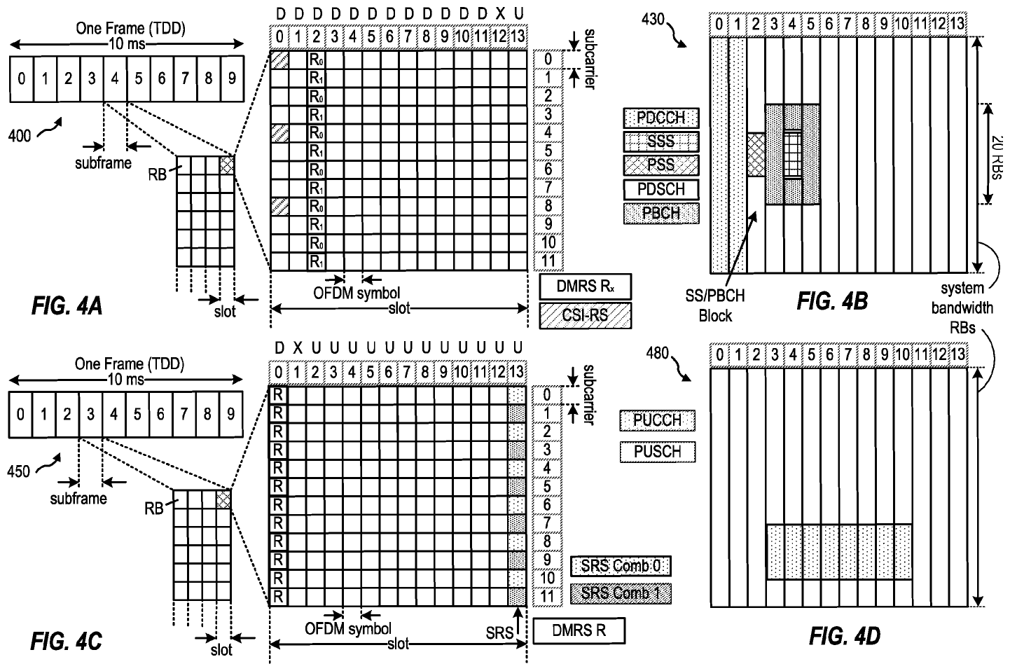

FIGS. 4A, 4B, 4C, and 4D depict aspects of data structures for a wireless communication network, such as wireless communication network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communication systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and in the time domain with SC-FDM.

A wireless communication frame structure may be frequency division duplex (FDD), in which for a particular set of subcarriers and subframes within the set of subcarriers are dedicated for either DL or UL. Wireless communication frame structures may also be time division duplex (TDD), in which for a particular set of subcarriers and subframes within the set of subcarriers are dedicated for both DL and UL.

In FIGS. 4A and 4C, the wireless communication frame structure is TDD where D is DL, U is UL, and X is flexible for use between DL/UL. UEs may be configured with the slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot configuration. Subframes may also include mini-slots, which generally have fewer symbols than an entire slot. Other wireless communication technologies may have a different frame structure and/or different channels.

Generally, the number of slots within a subframe is based on a slot configuration and a numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and channel state information reference signals (CSI-RS) for channel estimation at the UE. The RS may also include beam measurement RS (BRS), beam refinement RS (BRRS), and phase tracking RS (PT-RS).

FIG. 4B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may also transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Non-Terrestrial Networks (NTNs)

As noted above, non-terrestrial networks (NTNs) are one option being explored to expand coverage of wireless networks.

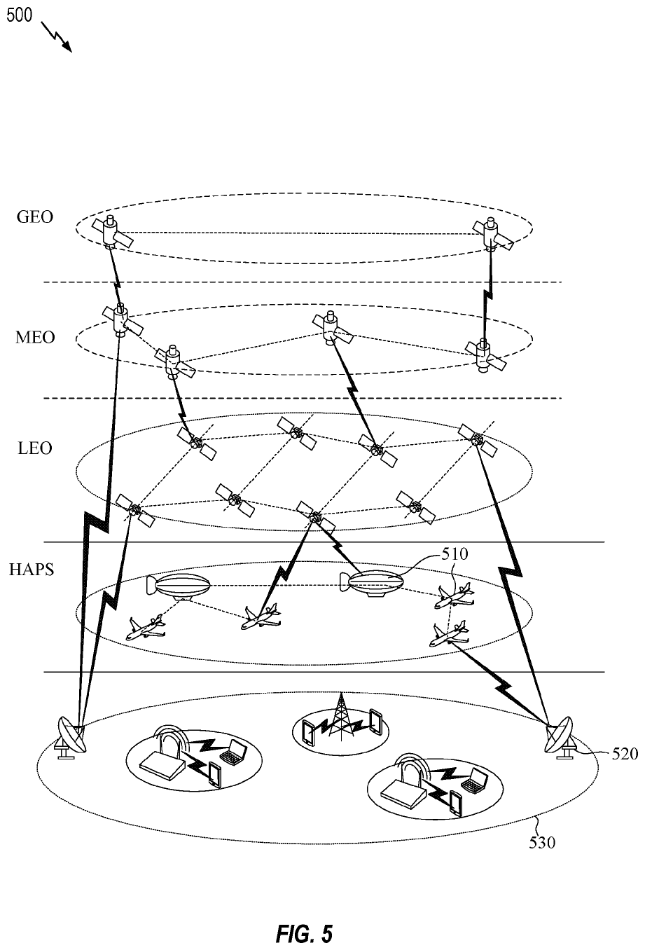

As illustrated in FIG. 5, NTNs include satellite communication networks that utilize platforms such as geosynchronous Earth orbiting (GEO), medium Earth orbiting (MEO), and low Earth orbiting (LEO) satellites. NTNs also include HAPS that utilize airborne platforms 510, such as airplanes, balloons, and airships. Returning to FIG. 5, HAPS deployed network entities (base stations) may communicate directly to UEs or, in some cases, air-to-ground base stations 520 may provide connectivity between the various systems and the various systems may provide a relatively large coverage area 530.

The various types of networks are deployed at different altitudes. For example, GEO satellites are typically deployed at an altitude over 35,000 km, LEO satellites are typically deployed at altitudes around 1200 km, while HAPS platforms are typically deployed at altitudes between 20-50 km.

### Aspects Related to Periodic Beam Switching Report for HAPS

As noted above, one potential challenge in HAPS deployments, is that the aerially deployed platform base station antenna surface may not be stable. In contrast to satellites that transmit information about their current and predicted location (referred to as ephemeris data), HAPS platforms are assumed to be static. In practice, however, a HAPS platform deployed in the stratosphere may be subject to rapid movements.

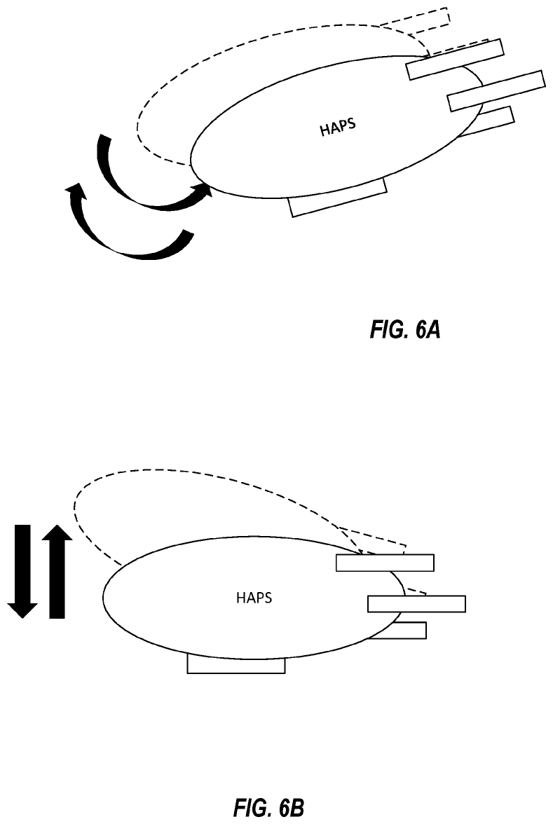

For example, a HAPS platform may rapidly move (jerk) side-to-side as illustrated in FIG. 6A or up-and-down as illustrated in FIG. 6B due to various conditions (e.g., wind). As noted above, the movements may be significant (e.g., up to one degree or more), even when using a stabilizing device. Due to the larger distance (from the HAPS platform to the ground), just one degree of movement may lead to a coverage bias of several kilometers, given typical beam widths and coverage diameters.

As noted above, one difference from HAPS and other NTN deployments (such as GEO/MEO/LEO satellites) is the lack of ephemeris data, which may lead to the false assumption that the HAPS platform is static. Rather than static, the instability of the platform can mean the fixed cells and beam coverage areas at the ground are not stable (e.g., with a potential coverage bias of several kilometers on the ground). To account for this, the beam switching or cell mobility procedures for HAPS may be periodic, while the beam switching or cell mobility for a satellite or aircraft may not be.

Aspects of the present disclosure, however, provide enhancements to beam measurement reporting and management procedures that may help mitigate the impact of such potential problems caused by the instability of HAPS gNB antenna surfaces. The techniques presented herein may be applicable to periodic beam switching pattern reporting initiated by a UE or by a network entity (HAPS-initiated).

The periodic beam switching pattern based reporting proposed herein may be initiated by a HAPS network entity (e.g., gNB) or by a UE.

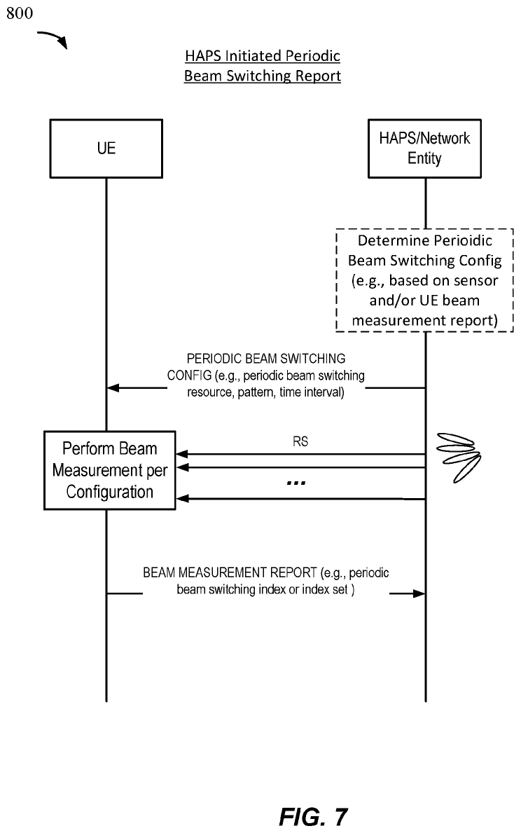

HAPS initiated periodic beam switching pattern based reporting may be understood with reference to the call flow diagram 700 of FIG. 7. As illustrated, the HAPS entity may configure the UE with a configuration for periodic beam switching reporting. In some cases, the HAPS entity may determine details of the configuration based on sensor (e.g., stability sensor) and/or previous UE beam measurement report results. The configuration may indicate resources the UE is to measure, as well as timing, periodicity for sending a report, and the like. The measurements may be based, for example, on periodically transmitted CSI-RS, SSBs, or other downlink RS.

In some cases, the configuration may indicate one or more conditions that, when met, trigger the UE to report the periodic beam switching report. For example, the conditions may be based on various relative or absolute thresholds (e.g., based on reference signal received power measurements) that might indicate beam switching might be beneficial.

As illustrated, the UE may perform beam measurement according to the configuration. The HAPS network entity (e.g., base station/gNB) may send RS (on different resources indicated in the configuration), while sweeping through set of beams. The UE then reports the beam measurement results to the HAPS network entity, according to the configuration. The configuration may be designed to detect rapid movements of the HAPS platform and allow for beam switching to mitigate the adverse impact (e.g., and overcome the potential bias in coverage area).

For HAPS initiated periodic beam switching reporting, a UE may expect to receive a periodic beam switching configuration from the HAPS network entity and report beam measurement results to the HAPS based on the received configuration, as shown in FIG. 7.

In some cases, the periodic beam switching configuration may be included in an existing system information block (SIB) or a new SIB (e.g., SIBX). The periodic beam switching configuration may be included in an existing or new IE.

The periodic beam switching configuration may be broadcast to UEs as a common configuration, or unicast to UEs as a dedicated configuration. As noted above, the periodic beam switching configuration may contain a set of periodic beam switching resources, patterns, time intervals, and the like.

In some cases, the UE may report a periodic beam switching index or index set to the HAPS, based on the HAPS configuration. The index set may contain a resource index, a pattern index, a time interval index, or a combination thereof. In some cases, the UE may report the periodicity of the beam switching pattern to the HAPS.

In some cases, the UE may report the beam measurement results to the HAPS explicitly. For example, the UE may report the periodic beam measurement results via a new (or existing) MAC-CE, in a new (or existing) dedicated control channel (DCCH) message, in downlink control information (DCI), or radio resource control (RRC) signaling.

In other cases, the UE may report the periodic beam measurement results to the HAPS implicitly. For example, the UE may use random access channel (RACH) occasions (RO) or configured grant (CG) occasions to implicitly indicate the periodic beam measurement results to HAPS. In other words, different ROs or CG occasions may represent different results, such that the selected RO/CG implicitly indicates a corresponding result. In some cases, the relationship (mapping) between RO or CG occasions and periodic beam measurement results may be pre-configured (e.g., and specified in a standard).

In some cases, a HAPS entity may adapt (update) the periodic beam switching configuration based on current conditions. For example, the HAPS entity may configure the periodic beam switching configuration for the UE, based on its stabilizer sensor measurement or a UE beam measurement report. This may allow the HAPS entity to tailor the measurement resources or change the periodicity for more frequent reporting if the platform is moving (as indicated by the reported or sensor measurements).

In the case that the periodic beam switching configuration is based on a HAPS stabilizer sensor measurement or UE beam measurement report, the configuration may be included in a new (or existing) SIBX, or a new (or existing) IE. As indicated previously, the periodic beam switching configuration may be broadcast to UEs as a common configuration, or unicast to UEs as a dedicated configuration. The periodic beam switching configuration may contain a set of periodic beam switching resource, pattern, time interval, or a combination thereof.

In some cases, the HAPS entity may indicate UE whether the UE is to report the periodic beam measurement results explicitly or implicitly. For example, the HAPS entity may indicate the UE is to report the periodic beam measurement results explicitly in a new MAC-CE, or a new DCCH message, or DCI, or RRC signaling. As an alternative (or in addition), the HAPS entity may indicate the UE is to report the periodic beam measurement results implicitly by using RO or CG occasions.

In some cases, the HAPS entity may indicate the UE to report the periodicity of the beam switching pattern. The HAPS entity may also indicate, to the UE, whether to report the periodic beam measurement results directly or using an index or index set. In such cases, the index or index set may be configured for the UE or pre-configured (e.g., defined in a standard).

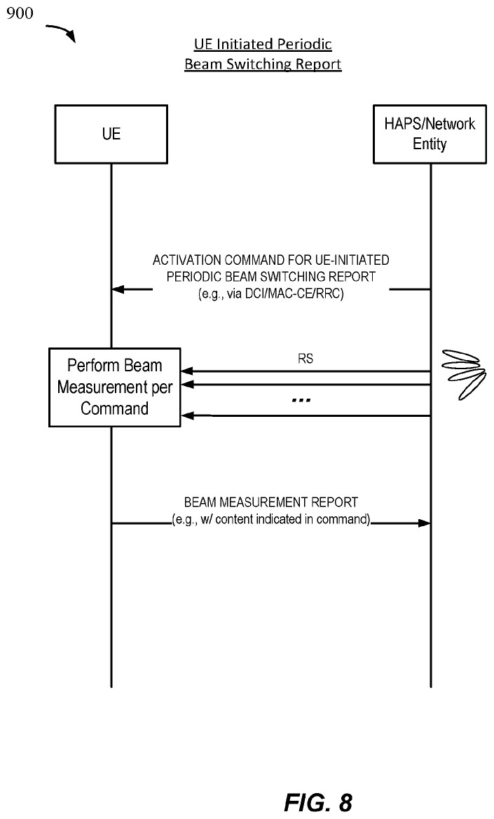

As illustrated in the call flow diagram 800 of FIG. 8, for UE initiated periodic beam switching pattern based reporting a UE may receive an activation/deactivation command (e.g., transmitted from the HAPS entity) which activates/deactivates UE-initiated periodic beam switching reporting. For example, such an activation/deactivation command may be conveyed via a MAC CE, DCI, or an RRC message.

In some cases, a message containing an activation/deactivation command for UE initiated periodic beam switching report may further include additional information or indications. For example, the message containing the activation/deactivation command may also include one or more of: an indication of whether to explicitly or implicitly report, a UE initiated periodic beam switching report resource, or one or more condition(s) that UE may report the periodic beam switching report. The message containing the activation/deactivation command may also include an indication of the content(s) to include in the periodic beam switching report and a maximum period of beam measurement for periodic beam switching pattern.

The message containing activation/deactivation command for UE initiated periodic beam switching report may be DCI/MAC-CE/RRC signaling.

### Example Operations of a Network Entity

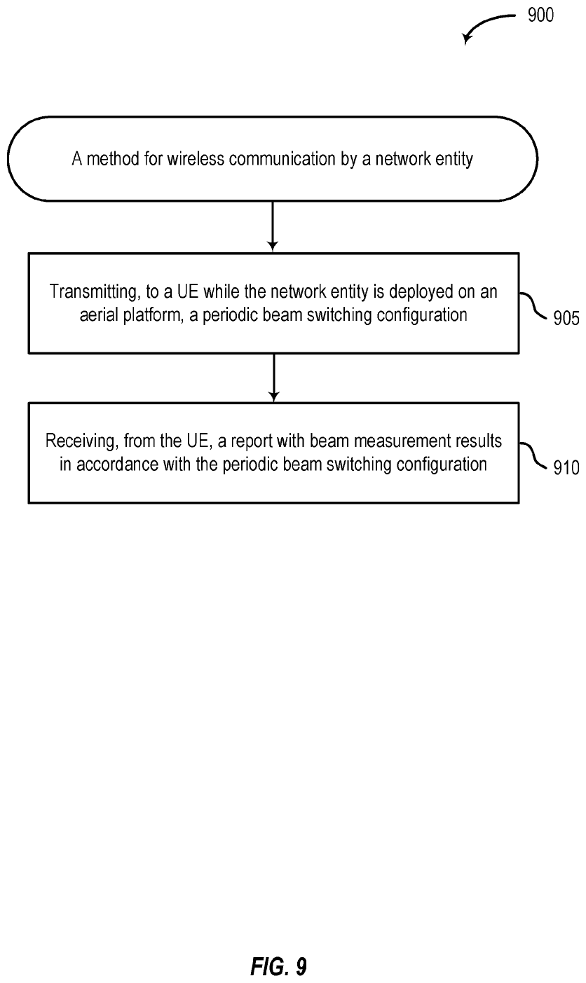

FIG. 9 shows a method 900 for wireless communication by a network entity, such as BS 102 of FIGS. 1 and 3, or a disaggregated base station as discussed with respect to FIG. 2.

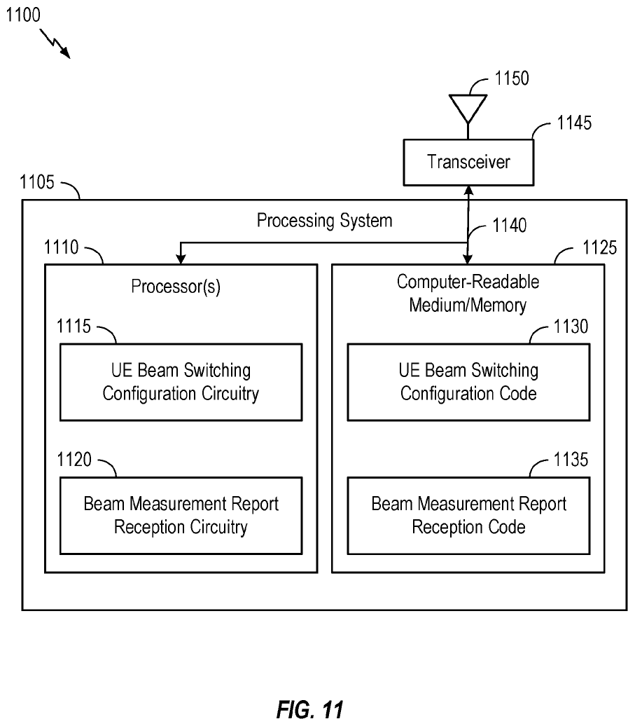

Method 900 begins at 905 with transmitting, to a UE while the network entity is deployed on an aerial platform, a periodic beam switching configuration. In some cases, the operations of this step refer to, or may be performed by, UE beam switching configuration circuitry as described with reference to FIG. 11.

Method 900 then proceeds to step 910 with receiving, from the UE, a report with beam measurement results in accordance with the periodic beam switching configuration. In some cases, the operations of this step refer to, or may be performed by, beam measurement report reception circuitry as described with reference to FIG. 11.

Various aspects relate to the method 900, including the following aspects.

In some aspects, the periodic beam switching configuration is transmitted via at least one of a SIB or an IE. In some aspects, the period periodic beam switching configuration is transmitted as: broadcast signaling as a common configuration; or unicast signaling as a dedicated configuration to a set of one or more UEs. In some aspects, the periodic beam switching configuration indicates at least one of: a set of periodic beam switching resources, a pattern of the set of periodic beam switching resources, or a time interval of the set of periodic beam switching resources.

In some aspects, the report comprises at least one of: a periodic beam switching index or a periodic beam switching index set, wherein the beam switching index set comprises at least one of a resource index, a pattern index, or a time interval index. In some aspects, the report indicates a periodicity of the beam switching pattern to the HAPS. In some aspects, the report is conveyed in at least one of a MAC-CE, DCCH, control information, or RRC signaling. In some aspects, the UE reports the measurement results via selection of a RO or a CG occasion, based on a relationship between the RO or CG to periodic beam measurement results.

In some aspects, method 900 further includes determining the periodic beam switching configuration based on one or more sensor measurements taken at the network entity.

In some aspects, method 900 further includes determining the periodic beam switching configuration based on one or more previously received reports with beam measurement results from the UE.

In some aspects, method 900 further includes transmitting the UE signaling with a command to activate or deactivate the UE from initiating transmission of the report with beam measurement results in accordance with the periodic beam switching configuration. In some aspects, the signaling further indicates at least one of: whether the UE is to report beam measurement results explicitly or implicitly; a periodic beam switching report resource; one or more conditions that, if met, trigger the UE to send the report; one or more contents of the report; or a maximum period of beam measurement for a periodic beam switching pattern. In some aspects, the signaling comprises at least one of DCI, MAC-CE, or RRC signaling.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a User Equipment

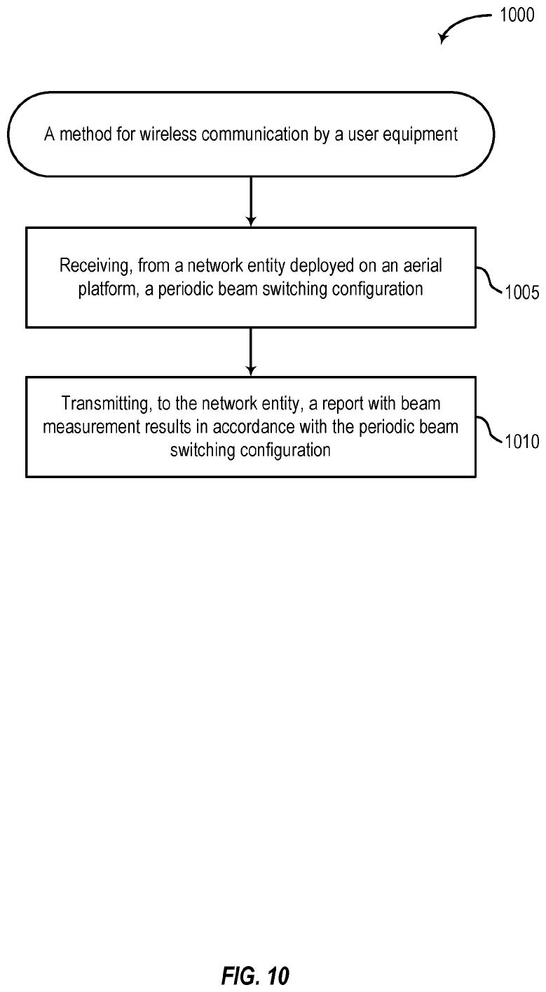

FIG. 10 shows a method 1000 for wireless communication by a UE, such as UE 104 of FIGS. 1 and 3.

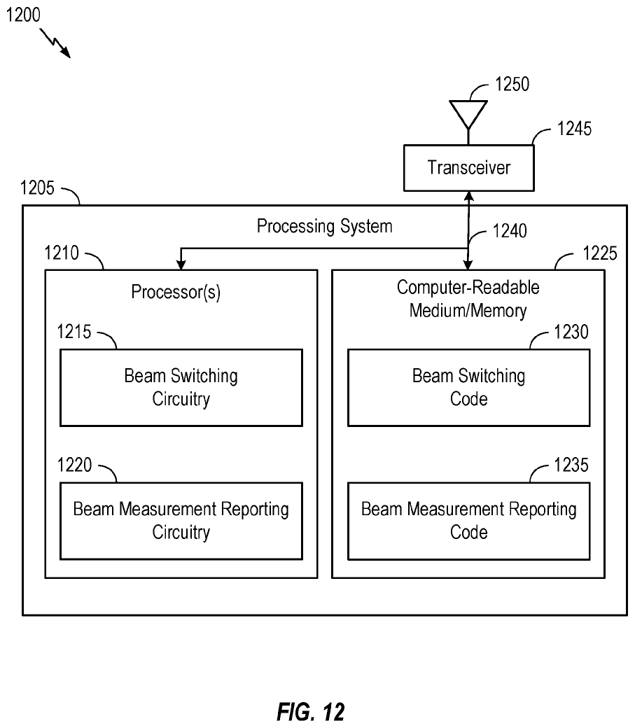

Method 1000 begins at 1005 with receiving, from a network entity deployed on an aerial platform, a periodic beam switching configuration. In some cases, the operations of this step refer to, or may be performed by, beam switching circuitry as described with reference to FIG. 12.

Method 1000 then proceeds to step 1010 with transmitting, to the network entity, a report with beam measurement results in accordance with the periodic beam switching configuration. In some cases, the operations of this step refer to, or may be performed by, beam measurement reporting circuitry as described with reference to FIG. 12.

Various aspects relate to the method 1000, including the following aspects.

In some aspects, the periodic beam switching configuration is received via at least one of a SIB or an IE. In some aspects, the period periodic beam switching configuration is received as: broadcast signaling as a common configuration; or unicast signaling as a dedicated configuration to a set of one or more UEs. In some aspects, the periodic beam switching configuration indicates at least one of: a set of periodic beam switching resources, a pattern of the set of periodic beam switching resources, or a time interval of the set of periodic beam switching resources.

In some aspects, the report comprises at least one of: a periodic beam switching index or a periodic beam switching index set, wherein the beam switching index set comprises at least one of a resource index, a pattern index, or a time interval index. In some aspects, the report indicates a periodicity of the beam switching pattern to the HAPS. In some aspects, the report is conveyed in at least one of a MAC-CE, DCCH, control information, or RRC signaling. In some aspects, the UE reports the measurement results via selection of a RO or a CG occasion, based on a relationship between the RO or CG to periodic beam measurement results.

In some aspects, method 1000 further includes receiving, from the network entity, signaling with a command to activate or deactivate the UE from initiating transmission of the report with beam measurement results in accordance with the periodic beam switching configuration. In some aspects, the signaling further indicates at least one of: whether the UE is to report beam measurement results explicitly or implicitly; a periodic beam switching report resource; one or more conditions that, if met, trigger the UE to send the report; one or more contents of the report; or a maximum period of beam measurement for a periodic beam switching pattern. In some aspects, the signaling comprises at least one of DCI, MAC-CE, or RRC signaling.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communications Devices

FIG. 11 depicts aspects of an example communications device 1100. In some aspects, communications device 1100 is a network entity, such as BS 102 described above with respect to FIGS. 1 and 3.

The communications device 1100 includes a processing system 1105 coupled to the transceiver 1145 (e.g., a transmitter and/or a receiver). The transceiver 1145 is configured to transmit and receive signals for the communications device 1100 via the antenna 1150, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1125 via a bus 1140. In certain aspects, the computer-readable medium/memory 1125 is configured to store instructions (e.g., computer-executable code) that when executed by the one or more processors 1110, cause the one or more processors 1110 to perform the method 900 described with respect to FIG. 9, or any aspect related to it. Note that reference to a processor of communications device 1100 performing a function may include one or more processors 1110 of communications device 1100 performing that function.

In the depicted example, the computer-readable medium/memory 1125 stores code (e.g., executable instructions), such as UE beam switching configuration code 1130 and beam measurement report reception code 1135. Processing of the UE beam switching configuration code 1130 and beam measurement report reception code 1135 may cause the communications device 1100 to perform the method 900 described with respect to FIG. 9, or any aspect related to it.

The one or more processors 1110 include circuitry configured to implement (e.g., execute) the code stored in the computer-readable medium/memory 1125, including circuitry such as UE beam switching configuration circuitry 1115 and beam measurement report reception circuitry 1120. Processing with UE beam switching configuration circuitry 1115 and beam measurement report reception circuitry 1120 may cause the communications device 1100 to perform the method 900 as described with respect to FIG. 9, or any aspect related to it.

Various components of the communications device 1100 may provide means for performing the method 900 as described with respect to FIG. 9, or any aspect related to it. Means for transmitting, sending or outputting for transmission may include transceivers 332 and/or antenna(s) 334 of the BS 102 illustrated in FIG. 3 and/or the transceiver 1145 and the antenna 1150 of the communications device 1100 in FIG. 11. Means for receiving or obtaining may include transceivers 332 and/or antenna(s) 334 of the BS 102 illustrated in FIG. 3 and/or the transceiver 1145 and the antenna 1150 of the communications device 1100 in FIG. 11.

According to some aspects, UE beam switching configuration circuitry 1115 transmits, to a UE while the network entity is deployed on an aerial platform, a periodic beam switching configuration. According to some aspects, beam measurement report reception circuitry 1120 receives, from the UE, a report with beam measurement results in accordance with the periodic beam switching configuration.

In some aspects, the periodic beam switching configuration is transmitted via at least one of a SIB or an IE. In some aspects, the period periodic beam switching configuration is transmitted as: broadcast signaling as a common configuration; or unicast signaling as a dedicated configuration to a set of one or more UEs. In some aspects, the periodic beam switching configuration indicates at least one of: a set of periodic beam switching resources, a pattern of the set of periodic beam switching resources, or a time interval of the set of periodic beam switching resources. In some aspects, the report includes at least one of: a periodic beam switching index or a periodic beam switching index set, where the beam switching index set includes at least one of a resource index, a pattern index, or a time interval index. In some aspects, the report indicates a periodicity of the beam switching pattern to the HAPS. In some aspects, the report is conveyed in at least one of a MAC-CE, DCCH, control information, or RRC signaling. In some aspects, the UE reports the measurement results via selection of a RO or a CG occasion, based on a relationship between the RO or CG to periodic beam measurement results.

In some examples, UE beam switching configuration circuitry 1115 determines the periodic beam switching configuration based on one or more sensor measurements taken at the network entity. In some examples, UE beam switching configuration circuitry 1115 determines the periodic beam switching configuration based on one or more previously received reports with beam measurement results from the UE. In some examples, UE beam switching configuration circuitry 1115 transmits the UE signaling with a command to activate or deactivate the UE from initiating transmission of the report with beam measurement results in accordance with the periodic beam switching configuration. In some aspects, the signaling further indicates at least one of: whether the UE is to report beam measurement results explicitly or implicitly; a periodic beam switching report resource; one or more conditions that, if met, trigger the UE to send the report; one or more contents of the report; or a maximum period of beam measurement for a periodic beam switching pattern. In some aspects, the signaling includes at least one of DCI, MAC-CE, or RRC signaling.

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to the transceiver 1245 (e.g., a transmitter and/or a receiver). The transceiver 1245 is configured to transmit and receive signals for the communications device 1200 via the antenna 1250, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1225 via a bus 1240. In certain aspects, the computer-readable medium/memory 1225 is configured to store instructions (e.g., computer-executable code) that when executed by the one or more processors 1210, cause the one or more processors 1210 to perform the method 1000 described with respect to FIG. 10, or any aspect related to it. Note that reference to a processor performing a function of communications device 1200 may include one or more processors 1210 performing that function of communications device 1200.

In the depicted example, computer-readable medium/memory 1225 stores code (e.g., executable instructions), such as beam switching code 1230 and beam measurement reporting code 1235. Processing of the beam switching code 1230 and beam measurement reporting code 1235 may cause the communications device 1200 to perform the method 1000 described with respect to FIG. 10, or any aspect related to it.

The one or more processors 1210 include circuitry configured to implement (e.g., execute) the code stored in the computer-readable medium/memory 1225, including circuitry such as beam switching circuitry 1215 and beam measurement reporting circuitry 1220. Processing with beam switching circuitry 1215 and beam measurement reporting circuitry 1220 may cause the communications device 1200 to perform the method 1000 described with respect to FIG. 10, or any aspect related to it.

Various components of the communications device 1200 may provide means for performing the method 1000 described with respect to FIG. 10, or any aspect related to it. For example, means for transmitting, sending or outputting for transmission may include transceivers 354 and/or antenna(s) 352 of the UE 104 illustrated in FIG. 3 and/or the transceiver 1245 and the antenna 1250 of the communications device 1200 in FIG. 12. Means for receiving or obtaining may include transceivers 354 and/or antenna(s) 352 of the UE 104 illustrated in FIG. 3 and/or the transceiver 1245 and the antenna 1250 of the communications device 1200 in FIG. 12.

According to some aspects, beam switching circuitry 1215 receives, from a network entity deployed on an aerial platform, a periodic beam switching configuration. According to some aspects, beam measurement reporting circuitry 1220 transmits, to the network entity, a report with beam measurement results in accordance with the periodic beam switching configuration.

In some aspects, the periodic beam switching configuration is received via at least one of a SIB or an IE. In some aspects, the period periodic beam switching configuration is received as: broadcast signaling as a common configuration; or unicast signaling as a dedicated configuration to a set of one or more UEs. In some aspects, the periodic beam switching configuration indicates at least one of: a set of periodic beam switching resources, a pattern of the set of periodic beam switching resources, or a time interval of the set of periodic beam switching resources.

In some aspects, the report includes at least one of: a periodic beam switching index or a periodic beam switching index set, where the beam switching index set includes at least one of a resource index, a pattern index, or a time interval index. In some aspects, the report indicates a periodicity of the beam switching pattern to the HAPS. In some aspects, the report is conveyed in at least one of a MAC-CE, DCCH, control information, or RRC signaling. In some aspects, the UE reports the measurement results via selection of a RO or a CG occasion, based on a relationship between the RO or CG to periodic beam measurement results.

In some examples, beam measurement reporting circuitry 1220 receives, from the network entity, signaling with a command to activate or deactivate the UE from initiating transmission of the report with beam measurement results in accordance with the periodic beam switching configuration. In some aspects, the signaling further indicates at least one of: whether the UE is to report beam measurement results explicitly or implicitly; a periodic beam switching report resource; one or more conditions that, if met, trigger the UE to send the report; one or more contents of the report; or a maximum period of beam measurement for a periodic beam switching pattern. In some aspects, the signaling includes at least one of DCI, MAC-CE, or RRC signaling.

### Example Clauses

Implementation examples are described in the following numbered clauses:
Clause 1: A method for wireless communications by a network entity, comprising: transmitting, to a UE while the network entity is deployed on an aerial platform, a periodic beam switching configuration; and receiving, from the UE, a report with beam measurement results in accordance with the periodic beam switching configuration.
Clause 2: The method of Clause 1, wherein the periodic beam switching configuration is transmitted via at least one of a SIB or an IE.
Clause 3: The method of any one of Clauses 1-2, wherein the period periodic beam switching configuration is transmitted as: broadcast signaling as a common configuration; or unicast signaling as a dedicated configuration to a set of one or more UEs.
Clause 4: The method of any one of Clauses 1-3, wherein the periodic beam switching configuration indicates at least one of: a set of periodic beam switching resources, a pattern of the set of periodic beam switching resources, or a time interval of the set of periodic beam switching resources.
Clause 5: The method of any one of Clauses 1-4, wherein the report comprises at least one of: a periodic beam switching index or a periodic beam switching index set, wherein the beam switching index set comprises at least one of a resource index, a pattern index, or a time interval index.
Clause 6: The method of any one of Clauses 1-5, wherein the report indicates a periodicity of the beam switching pattern to the HAPS.
Clause 7: The method of any one of Clauses 1-6, wherein the report is conveyed in at least one of a MAC-CE, DCCH, control information, or RRC signaling.
Clause 8: The method of any one of Clauses 1-7, wherein the UE reports the measurement results via selection of a RO or a CG occasion, based on a relationship between the RO or CG to periodic beam measurement results.
Clause 9: The method of any one of Clauses 1-8, further comprising: determining the periodic beam switching configuration based on one or more sensor measurements taken at the network entity.
Clause 10: The method of any one of Clauses 1-9, further comprising: determining the periodic beam switching configuration based on one or more previously received reports with beam measurement results from the UE.
Clause 11: The method of any one of Clauses 1-10, further comprising: transmitting the UE signaling with a command to activate or deactivate the UE from initiating transmission of the report with beam measurement results in accordance with the periodic beam switching configuration.
Clause 12: The method of Clause 11, wherein the signaling further indicates at least one of: whether the UE is to report beam measurement results explicitly or implicitly; a periodic beam switching report resource; one or more conditions that, if met, trigger the UE to send the report; one or more contents of the report; or a maximum period of beam measurement for a periodic beam switching pattern.
Clause 13: The method of Clause 11, wherein the signaling comprises at least one of DCI, MAC-CE, or RRC signaling.
Clause 14: A method for wireless communications by a UE, comprising: receiving, from a network entity deployed on an aerial platform, a periodic beam switching configuration; and transmitting, to the network entity, a report with beam measurement results in accordance with the periodic beam switching configuration.

Clause 15: The method of Clause 14, wherein the periodic beam switching configuration is received via at least one of a SIB or an IE.
Clause 16: The method of any one of Clauses 14 and 15, wherein the period periodic beam switching configuration is received as: broadcast signaling as a common configuration; or unicast signaling as a dedicated configuration to a set of one or more UEs.
Clause 17: The method of any one of Clauses 14-16, wherein the periodic beam switching configuration indicates at least one of: a set of periodic beam switching resources, a pattern of the set of periodic beam switching resources, or a time interval of the set of periodic beam switching resources.
Clause 18: The method of any one of Clauses 14-17, wherein the report comprises at least one of: a periodic beam switching index or a periodic beam switching index set, wherein the beam switching index set comprises at least one of a resource index, a pattern index, or a time interval index.
Clause 19: The method of any one of Clauses 14-18, wherein the report indicates a periodicity of the beam switching pattern to the HAPS.
Clause 20: The method of any one of Clauses 14-19, wherein the report is conveyed in at least one of a MAC-CE, DCCH, control information, or RRC signaling.
Clause 21: The method of any one of Clauses 14-20, wherein the UE reports the measurement results via selection of a RO or a CG occasion, based on a relationship between the RO or CG to periodic beam measurement results.
Clause 22: The method of any one of Clauses 14-21, further comprising: receiving, from the network entity, signaling with a command to activate or deactivate the UE from initiating transmission of the report with beam measurement results in accordance with the periodic beam switching configuration.
Clause 23: The method of Clause 22, wherein the signaling further indicates at least one of: whether the UE is to report beam measurement results explicitly or implicitly; a periodic beam switching report resource; one or more conditions that, if met, trigger the UE to send the report; one or more contents of the report; or a maximum period of beam measurement for a periodic beam switching pattern.
Clause 24: The method of Clause 22, wherein the signaling comprises at least one of DCI, MAC-CE, or RRC signaling.
Clause 25: A processing system, comprising: a memory comprising computer-executable instructions; one or more processors configured to execute the computer-executable instructions and cause the processing system to perform a method in accordance with any one of Clauses 1-24.
Clause 26: A processing system, comprising means for performing a method in accordance with any one of Clauses 1-24.
Clause 27: A non-transitory computer-readable medium comprising computer-executable instructions that, when executed by one or more processors of a processing system, cause the processing system to perform a method in accordance with any one of Clauses 1-24.
Clause 28: A computer program product embodied on a computer-readable storage medium comprising code for performing a method in accordance with any one of Clauses 1-24.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications by a network entity, comprising:
transmitting, to a user equipment (UE) while the network entity is deployed on an aerial platform, a periodic beam switching configuration; and
receiving, from the UE, a report with beam measurement results in accordance with the periodic beam switching configuration.

2. The method of claim 1, wherein the periodic beam switching configuration is transmitted via at least one of a system information block (SIB) or an information element (IE).

3. The method of claim 1, wherein the periodic beam switching configuration is transmitted as:
broadcast signaling as a common configuration; or
unicast signaling as a dedicated configuration to a set of one or more UEs.

4. The method of claim 1, wherein the periodic beam switching configuration indicates at least one of: a set of periodic beam switching resources, a pattern of the set of periodic beam switching resources, or a time interval of the set of periodic beam switching resources.

5. The method of claim 1, wherein the report comprises at least one of: a periodic beam switching index or a periodic beam switching index set, wherein the beam switching index set comprises at least one of a resource index, a pattern index, or a time interval index.

6. The method of claim 1, wherein the report indicates a periodicity of the beam switching pattern.

7. The method of claim 1, wherein the report is conveyed in at least one of a medium access control (MAC) control element (MAC-CE), dedicated control channel (DCCH), control information, or radio resource control (RRC) signaling.

8. The method of claim 1, wherein the UE reports the measurement results via selection of a random access channel (RACH) occasion (RO) or a configured grant (CG) occasion, based on a relationship between the RO or CG to periodic beam measurement results.

9. The method of claim 1, further comprising determining the periodic beam switching configuration based on one or more sensor measurements taken at the network entity.

10. The method of claim 1, further comprising determining the periodic beam switching configuration based on one or more previously received reports with beam measurement results from the UE.

11. The method of claim 1, further comprising transmitting the UE signaling with a command to activate or deactivate the UE from initiating transmission of the report with beam measurement results in accordance with the periodic beam switching configuration.

12. The method of claim 11, wherein the signaling further indicates at least one of:
whether the UE is to report beam measurement results explicitly or implicitly;
a periodic beam switching report resource;
one or more conditions that, if met, trigger the UE to send the report;
one or more contents of the report; or
a maximum period of beam measurement for a periodic beam switching pattern.

13. The method of claim 11, wherein the signaling comprises at least one of downlink control information (DCI), medium access control (MAC) control element (MAC-CE), or radio resource control (RRC) signaling.

14. A method for wireless communications by a user equipment (UE), comprising:
receiving, from a network entity deployed on an aerial platform, a periodic beam switching configuration; and
transmitting, to the network entity, a report with beam measurement results in accordance with the periodic beam switching configuration.

15. The method of claim 14, wherein the periodic beam switching configuration is received via at least one of a system information block (SIB) or an information element (IE).

16. The method of claim 14, wherein the periodic beam switching configuration is received as:
broadcast signaling as a common configuration; or
unicast signaling as a dedicated configuration to a set of one or more UEs.

17. The method of claim 14, wherein the periodic beam switching configuration indicates at least one of: a set of periodic beam switching resources, a pattern of the set of periodic beam switching resources, or a time interval of the set of periodic beam switching resources.

18. The method of claim 14, wherein the report comprises at least one of: a periodic beam switching index or a periodic beam switching index set, wherein the beam switching index set comprises at least one of a resource index, a pattern index, or a time interval index.

19. The method of claim 14, wherein the report indicates a periodicity of the (Original) beam switching pattern.

20. The method of claim 14, wherein the report is conveyed in at least one of a medium access control (MAC) control element (MAC-CE), dedicated control channel (DCCH), control information, or radio resource control (RRC) signaling.

21. The method of claim 14, wherein the UE reports the measurement results via selection of a random access channel (RACH) occasion (RO) or a configured grant (CG) occasion, based on a relationship between the RO or CG to periodic beam measurement results.

22. The method of claim 14, further comprising receiving, from the network entity, signaling with a command to activate or deactivate the UE from initiating transmission of the report with beam measurement results in accordance with the periodic beam switching configuration.

23. The method of claim 22, wherein the signaling further indicates at least one of:
whether the UE is to report beam measurement results explicitly or implicitly;
a periodic beam switching report resource;
one or more conditions that, if met, trigger the UE to send the report;
one or more contents of the report; or
a maximum period of beam measurement for a periodic beam switching pattern.

24. The method of claim 22, wherein the signaling comprises at least one of downlink control information (DCI), medium access control (MAC) control element (MAC-CE), or radio resource control (RRC) signaling.

25-28. (canceled)

29. An apparatus, comprising: at least one memory comprising computer-executable instructions; one or more processors configured to execute the computer-executable instructions and cause the apparatus:
transmit, to a user equipment (UE) while the network entity is deployed on an aerial platform, a periodic beam switching configuration; and
receive, from the UE, a report with beam measurement results in accordance with the periodic beam switching configuration.

30. An apparatus, comprising: at least one memory comprising computer-executable instructions; one or more processors configured to execute the computer-executable instructions and cause the apparatus:
receive, from a network entity deployed on an aerial platform, a periodic beam switching configuration; and
transmit, to the network entity, a report with beam measurement results in accordance with the periodic beam switching configuration.
